(19) United States
(12) Patent Application Publication
(10) Pub. No.: US 2026/0088558 A1
(43) Pub. Date: Mar. 26, 2026

(54) WATERPROOF SOCKET

(71) Applicant: Gongshe Electronic Technology (Dongguan) Co., Ltd., Dongguan (CN)

(72) Inventor: XUANLONG XIAO, Dongguan (CN)

(21) Appl. No.: 18/897,523

(22) Filed: Sep. 26, 2024

(30) Foreign Application Priority Data
Sep. 24, 2024 (CN) 202411335636.1

(51) Int. Cl. H01R 13/52

(52) U.S. Cl. CPC H01R 13/5202

(57) ABSTRACT

A waterproof socket is provided. Which includes: a housing including a base and a cover that are matched with each other, the base and the cover are connected to form an installation cavity, the base is provided with an isolation chamber, the isolation chamber divides the installation cavity into a first installation space and a second installation space that are not communicated with each other; a socket circuit provided in the first installation space; an adapter provided in the second installation space, a jack socket provided in the cover at a position corresponding to the second installation space; the jack socket is configured to be matched with a plug, and when the plug is inserted into the jack socket, the plug is electrically connected to the adapter; and a triggering component including a movable part that penetrates the isolation chamber.

### CROSS-REFERENCE TO RELATED APPLICATIONS

This application claims priority to Chinese Patent Application No. 202411335636.1, filed on Sep. 24, 2024, which is hereby incorporated by reference in its entirety.

### TECHNICAL FIELD

The present disclosure relates to the field of electric devices technologies, and in particular, to a waterproof socket.

### BACKGROUND

With an improvement of people's living standards, the number of household appliances in each household is gradually increasing. Therefore, as devices that provide power interfaces for household appliances, a demand for socket and power strip has sharply increased. At the same time, people have higher requirements for the safety performance of socket and power strip. In daily life, children may intentionally or unintentionally touch the socket and plug socket with their fingers, or insert a conductor into the socket, which may result in electric shock accidents. In addition, in bathrooms or other damp environments with water (such as outdoor construction on rainy or snowy days), water can easily enter the socket and power strip through a jack socket, and thereby causing electric shock and short circuit accidents.

Some sockets and power strips in existing technology have certain functions of moisture-proof, waterproof, and anti-electric shock. These functions are usually implemented by installing a waterproof splash cover on the socket and power strip, providing with a leakage-and-short circuit protection device on the socket and the power strip, providing with an anti-touch protection door on the socket and the power strip, and providing with a waterproof sealing pad on the socket and the power strip.

However, the above solutions still have shortcomings in terms of reliability and security. Specifically, during a process of plugging and unplugging the plug and the socket, moisture can easily enter the socket through the jack socket, thereby causing damage to an internal circuit of the socket due to moisture.

### SUMMARY

The present application aims to solve at least one of the above technical problems by providing a waterproof socket that can improve a waterproof ability of the socket and enhance its safety.

In a first aspect, the present application provides a waterproof socket, including:
a housing, which includes a base and a cover that are matched with each other, the base and the cover are connected to form an installation cavity; the base is provided with an isolation chamber, which divides the installation cavity into a first installation space and a second installation space that are not communicated with each other;
a socket circuit provided in the first installation space;
an adapter provided in the second installation space, the cover is provided with a jack socket at a position corresponding to the second installation space, the jack socket is configured to be matched with a plug; the plug is electrically connected to the adapter when the plug is inserted into the jack socket;
a triggering component, which includes a movable part that penetrates the isolation chamber, a first end of the movable part is facing towards the socket circuit, a second end of the movable part forms an electrical connection with the adapter;
where the waterproof socket is configured to directly or indirectly trigger the first end of the movable part to be electrically connected to the socket circuit when the plug is inserted into the jack socket.

In some embodiments of the present disclosure, the adapter includes a bottom wall and two elastic walls connected to two opposite ends of the bottom wall; one ends of the two elastic walls away from the bottom wall are capable of being abutting against each other; where the plug includes a plug-in part, one plug-in part of the plug is inserted between the two elastic walls so as to achieve an electrical connection between the adapter and the plug-in part.

In some embodiments of the present disclosure, the triggering component further includes a triggering spring, which is connected to the adapter and located on one side of one of the two elastic walls;
the triggering spring is configured to abut against the movable part with direct or indirect contact of the plug when the plug is inserted into the jack socket, thereby driving the movable part to move and abut against a contact part in the socket circuit;
the contact part is electrically connected with the adapter by the movable part.

In some embodiments of the present disclosure, the triggering spring includes a bottom piece and two side pieces connected to the bottom piece, one ends of the two side pieces are connected to two opposite ends of the bottom piece; the other ends of the two side pieces abut against two opposite sides of one of the two elastic walls;
the bottom piece and the bottom wall are fixedly connected by a fastener.

In some embodiments of the present disclosure, the isolation chamber forms at least two second installation spaces, each of the at least two second installation spaces is provided corresponding to one plug-in part of the plug.

In some embodiments of the present disclosure, the isolation chamber is capable of being disassembled and installed on the base;
the cover is covered on the base, an edge area of the base is provided with an annular groove; an edge of the cover has an annular wall that matches with the annular groove, and at least a part of the annular wall is capable of being inserted into the annular groove.

In some embodiments of the present disclosure, a gap between the annular groove and the annular wall is filled and sealed by injecting a waterproof adhesive, or the gap between the annular groove and the annular wall is filled and sealed with a sealing ring.

In some embodiments of the present disclosure, the cover is provided with a sealing groove on one side of the cover facing the base, the sealing groove has a shape that matches with a contour of a top of the isolation chamber;
the top of the isolation chamber is inserted and matched with the sealing groove;
a gap between the sealing groove and the top of the isolation chamber is sealed by injecting a waterproof adhesive; or
the gap between the sealing groove and the top of the isolation chamber is sealed with a sealing ring.

In some embodiments of the present disclosure, the waterproof socket further includes a waterproof joint and a switch component;
the waterproof joint is provided at one end of the housing, and the switch component is configured to control a connection or a disconnection of the waterproof joint with the socket circuit.

In some embodiments of the present disclosure, the waterproof socket is further provided with a functional interface.

The present application provides a waterproof socket, the socket circuit is sealed in the first installation space and allows the plug and adapter to be provided in the second installation space. By providing with the triggering component, the movable part of the plug can be located at the second end of the second installation space, thereby causing the movable part to move at the first end of the first installation space. This enables the electrical connection of the socket circuit, the movable part, the adapter, and the plug in sequence. The first installation space and the second installation space are filled with a sealing element and are not communicated with each other, thereby avoiding water from entering the first installation space and improving the safety of the socket circuit, thereby improving an overall waterproofing of the waterproof socket and enhancing its safety.

### BRIEF DESCRIPTION OF DRAWINGS

FIG. 1 is a schematic structural diagram of a waterproof socket provided in an embodiment of the present application.

FIG. 2 is a partial exploded view of a housing of the waterproof socket shown in FIG. 1.

FIG. 3 is a schematic diagram of the waterproof socket shown in FIG. 2 after a cover being rotated.

FIG. 4 is a schematic diagram of a position of an installation cavity in the waterproof socket shown in FIG. 1.

FIG. 5 is an explosive structural schematic diagram of components in the position of the installation cavity shown in FIG. 4.

FIG. 6 is a schematic diagram of a connection between a triggering component and a socket circuit inside the waterproof socket shown in FIG. 1.

FIG. 7 is a schematic diagram of a connection between an adapter and a triggering spring at the position of the installation cavity shown in FIG. 5.

FIG. 8 is a schematic structural diagram of the waterproof socket provided in another embodiment of the present application.

FIG. 9 is a schematic sectional view of the waterproof socket provided in another embodiment the present application.

FIG. 10 is an exploded schematic diagram of the waterproof socket provided in another embodiment of the present application.

### DESCRIPTION OF EMBODIMENTS

The following will provide a clear and complete description of the technical solution in the embodiments of the present application, combined with the accompanying drawings. Obviously, the described embodiments are only a part of the embodiments of the present application, not all of them. Based on the embodiments in the present application, all other embodiments obtained by those skilled in the art without creative work are within the protection scope of the present application.

In a description of the present application, it should be understood that terms “center”, “longitudinal”, “transverse”, “length”, “width”, “thickness”, “up”, “down”, “front”, “back”, “left”, “right”, “vertical”, “horizontal”, “top”, “bottom”, “inside”, “outside” and other directional or positional relationships indicated are based on a directional or positional relationships shown in the accompanying drawings, only for a convenience of describing the present application and simplifying the description, and do not indicate or imply that the device or component referred to must have a specific orientation, be constructed and operated in a specific orientation, and therefore cannot be understood as a limitation of the present application. In addition, terms “first” and “second” are only used for a descriptive purpose and cannot be understood as indicating or implying a relative importance or implying the number of technical features indicated. Thus, features limited to “first” and “second” may explicitly or implicitly include one or more features. In the description of the present application, the meaning of “a plurality of”refers to two or more, unless otherwise specifically limited.

In the present application, the term “exemplary” is used to indicate used as an example, illustration, or demonstration. Any embodiments described as “exemplary” in the present application may not necessarily be interpreted as more preferred or advantageous than other embodiments. In order to enable those skilled in the art to implement and use the present application, the following description is provided. In the following description, details are listed for the purpose of explanation. It should be understood that those skilled in the art can recognize that the present application can be implemented without using these specific details. In other examples, well-known structures and processes will not be elaborated in detail to avoid unnecessary details that render the description of the present application obscure. Therefore, the present application is not intended to be limited to the shown embodiments, but is consistent with a wide scope of principles and features disclosed in the present application.

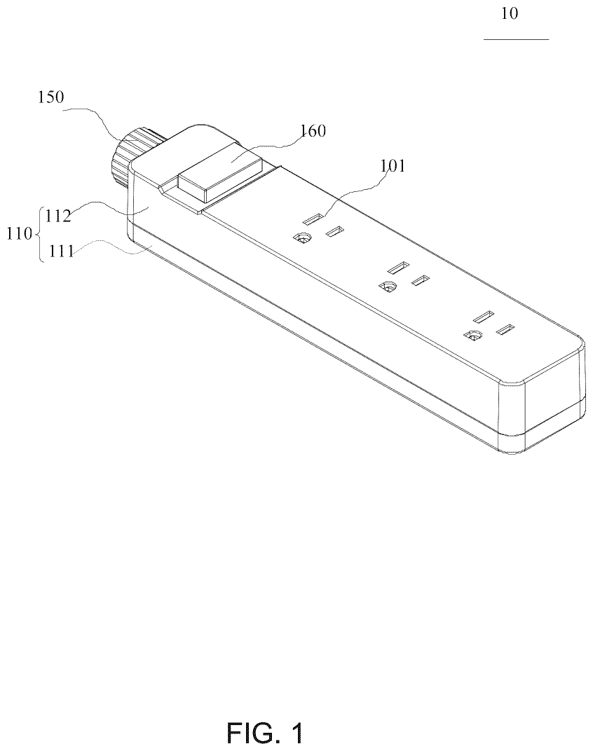

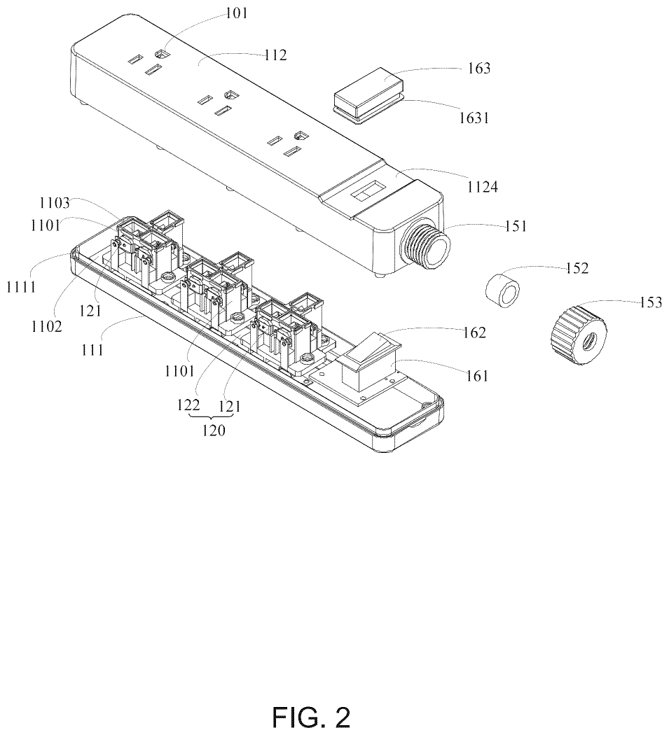

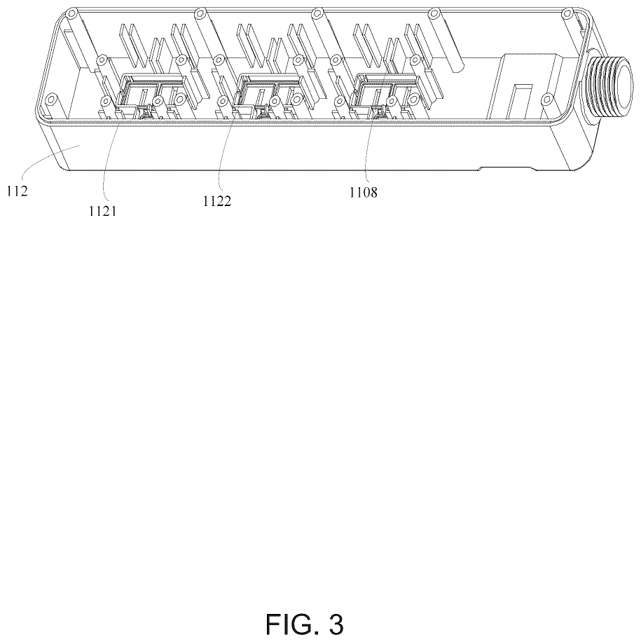

Referring to FIGS. 1-3, FIG. 1 is a schematic structural diagram of a waterproof socket provided in an embodiment of the present application; FIG. 2 is a partial exploded view of a housing of the waterproof socket shown in FIG. 1; FIG. 3 is a schematic diagram of the waterproof socket shown in FIG. 2 after a cover being rotated.

The waterproof socket 10 includes a housing 110, a socket circuit 120, an adapter 130, and a triggering component 140.

Where, the housing 110 includes a base 111 and a cover 112 that are matched with each other. The base 111 and the cover 112 are connected to form an installation cavity 1101. The base 111 is provided with an isolation chamber 113, which divides the installation cavity 1101 into a first installation space 1102 and a second installation space 1103 that are not communicated with each other. The socket circuit 120 is provided in the first installation space 1102; the adapter 130 is provided in the second installation space 1103, and the cover 112 is provided with a jack socket 101 at a position corresponding to the second installation space 1103. The jack socket 101 is configured to be matched with a plug, and when the plug is inserted into the jack socket 101, the plug is electrically connected to the adapter 130. The triggering component 140 includes a movable part 141 that penetrates the isolation chamber 113, a first end 1401 of the movable part 141 is facing the socket circuit 120, a second end 1402 of the movable part 141 is electrically connected to the adapter 130. The waterproof socket 10 is configured to directly or indirectly trigger the first end 1401 of the movable part 141 to be electrically connected to the socket circuit 120 when the plug is inserted into the jack socket 101.

Therefore, in this embodiment, the socket circuit 120 is sealed in the first installation space 1102, the plug and the adapter 130 are provided in the second installation space 1103. By providing with the triggering component 140, the movable part 141 of the plug can be located at the second end 1402 of the second installation space 1103, thereby causing the movable part 141 to move at the first end 1401 of the first installation space 1102. This enables an electrical connection of the socket circuit 120, the movable part 141, the adapter 130, and the plug in sequence. And the first installation space 1102 and the second installation space 1103 are filled with a sealing element and are not communicated, thereby preventing water from entering the first installation space 1102 and improving a safety of the socket circuit 120, thereby enhancing an overall waterproof performance of the waterproof socket 10 and improving its safety.

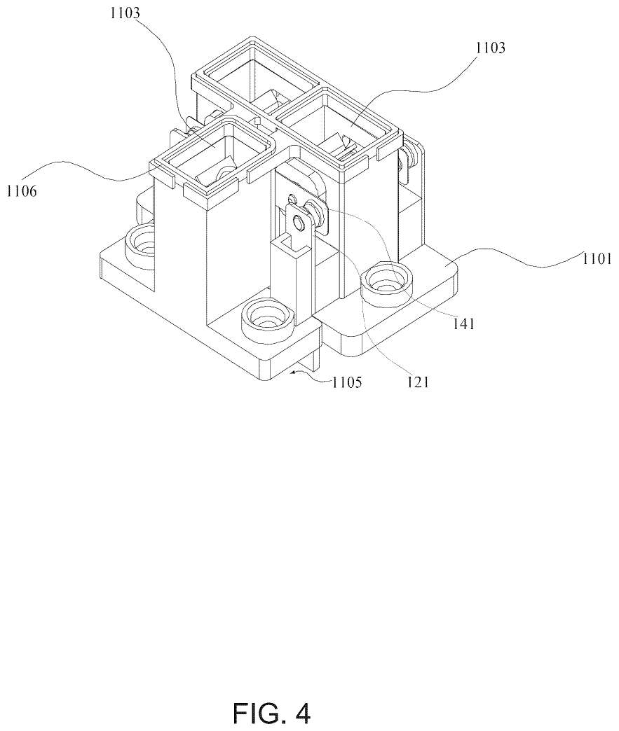

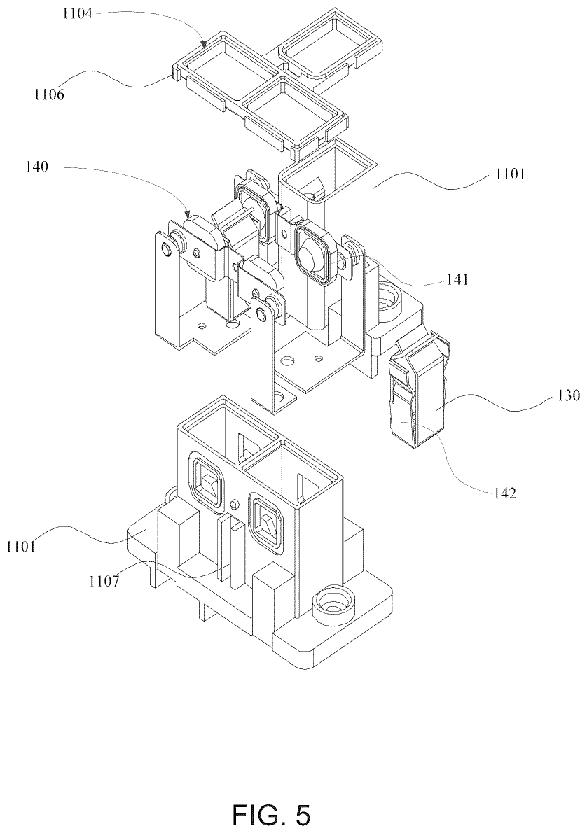

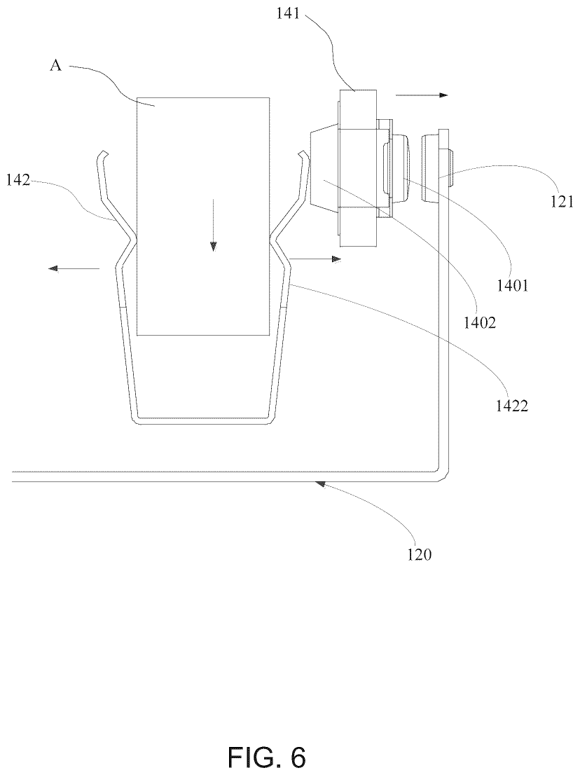

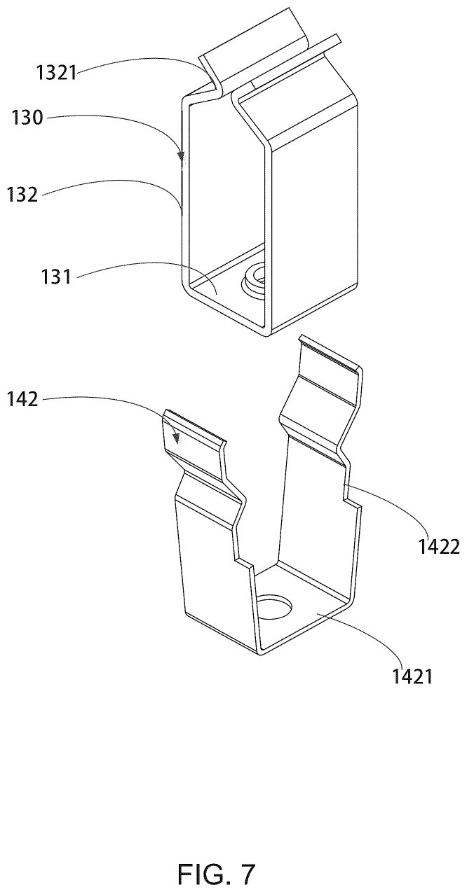

Please further refer to FIGS. 4-7, where FIG. 4 is a schematic diagram of a position of an installation cavity in the waterproof socket shown in FIG. 1; FIG. 5 is an explosive structural schematic diagram of components in the position of the installation cavity shown in FIG. 4; FIG. 6 is a schematic diagram of a connection between a triggering component and a socket circuit inside the waterproof socket shown in FIG. 1; FIG. 7 is a schematic diagram of a connection between an adapter and a triggering spring at the position of the installation cavity shown in FIG. 5.

Where the adapter 130 includes a bottom wall 131 and two elastic walls 132 connected to two opposite ends of the bottom wall 131. One ends of the two elastic walls 132 away from the bottom wall 131 are configured to abut against each other. When one plug-in part A (corresponding to a plug-in pin of the plug) of the plug is inserted between the two elastic walls 132, an electrical connection between the adapter and the plug-in part A can be achieved.

Where one ends of the two elastic walls 132 away from the bottom wall 131 have a bent portion 1321. The bent portions 1321 on the two elastic walls 132 are oriented towards each other, and upper ends of the bent portions 1321 on the two elastic walls 132 are expanded in a direction away from each other so as to form a trumpet-like shape. During an insertion process of the plug-in part A, an upper of the bent portion 1321 can guide the plug-in part A; the bent portions 1321 on the two elastic walls 132 are respectively abutted against two opposite sides of the plug-in portion A, thereby improving a stability of the plug-in portion A after insertion.

The triggering component 140 further includes a triggering spring 142, which is connected to the adapter 130 and located on one side of one of the two elastic walls 132. The triggering spring 142 is configured to abut against the movable part 141 with direct or indirection connect of the plug when the plug is inserted into the jack socket 101, thereby driving the movable part 141 to move and abut against the contact part 121 in the socket circuit 120. The movable part 141 electrically connects the contact part 121 with the adapter 130, thereby forming a conductive path through the electrical connection of the socket circuit 120, the contact part 121, the triggering spring 142, the movable part 141, and the adapter 130 in sequence. Where, the socket circuit 120 further includes a conductive connection piece 122, which is fixed at a bottom of the isolation chamber 113. One end of the conductive connection piece 122 is electrically connected to the contact part 121, and the other end thereof is extended along a bottom recess 1105 of the isolation chamber 113 and be electrically connected to a switch component 160 that will be described later.

Where, the triggering spring 142 includes a bottom piece 1421 and two side pieces 1422 connected to the bottom piece 1421. One ends of the two side pieces 1422 are respectively connected to two opposite ends of the bottom piece 1421. The other ends of the two side pieces 1422 tend to abut against the two opposite sides of one of the two elastic walls 132. The bottom piece 1421 is fixedly connected to the bottom wall 131 through a fastener.

In an implementation mode, in an opposite direction away from the bottom piece 1421, a gap between the two side pieces 1422 is configured to be gradually increased. Therefore, in the process of inserting the plug-in part A of the plug, other sides of the plug-in part can be respectively abutted against one of the two elastic walls 132, and as the plug-in part A is inserted, tops of the two side pieces 1422 can be separated in a direction away from each other, thereby causing the tops of the side pieces 1422 to abut against the movable part 141, and the movable part 141 is driven to move and contact with the contact part 121 so as to form an electrical connection.

In this embodiment, the isolation chamber 113 can form at least two second installation spaces 1103, each of which is provided corresponding to one plug-in part A of the plug.

In an implementation mode, when there are two plug plug-in parts A (when the plug only has a neutral pin and a live pin), the isolation chamber 113 is enclosed to form two second installation spaces 1103, and the two second installation spaces 1103 are arranged parallelly to each other.

When there are there plug plug-in parts A (for example, the plug has a neutral pin, a live pin, and a ground pin), the isolation chamber 113 is enclosed to form three second installation spaces 1103, and the three second installation spaces 1103 can be arranged in a shape of “triangle”. Where, in the same isolation chamber 113, the movable parts 141 corresponding to two below second installation spaces 1103 can be triggered synchronously, and a plurality of movable parts 141 of one plug can synchronously abut against the contact part 121.

In an implementation mode, a plurality of isolation chambers 113 can be arranged side by side and spaced apart on the base 111 so as to form a plurality of jack sockets 101.

In an implementation mode, please refer to FIGS. 2 and 4.

In this embodiment, the isolation chamber 113 can be disassembled and installed on the base 111; where, the isolation chamber 113 can be separately formed and fixed to the base 111 with a screw or other fasteners; a bottom of the isolation chamber 113 is not communicated with the base 111, which can further improve a sealing between the second installation space 1103 and the first installation space 1102. In this embodiment, it can facilitate a replacement of the isolation chamber 113, for example, the isolation chamber 113 with poor sealing can be disassembled and replaced, thereby improving the service life of the waterproof socket 10.

Where, a positioning mechanism is further provided between the isolation chamber 113 and the cover 112, which can position an installation position of the isolation chamber 113 when it is installed on the cover 112.

Please refer to FIGS. 3 and 5 together. A positioning protrusion 1107 is provided on an outer wall of the isolation chamber 113, and a sliding groove 1108 formed by a protruding wall is provided on an inner wall of the cover 112. When the cover 112 is covered, the positioning protrusion 1107 is partially inserted into the sliding groove 1108 to guide a downward direction of the cover 112, thereby improving an alignment accuracy of the cover 112 and enhancing a waterproof sealing effect of the waterproof socket 10.

In an implementation mode, the isolation chamber 113 may also be integrally formed with the base 111.

Please further refer to FIGS. 2 and 3.

In this embodiment, the cover 112 is covered on the base 111, an edge area of the base 111 is provided with an annular groove 1111. An edge of the cover 112 has an annular wall 1121 that matches with the annular groove 1111. The annular wall 1121 is at least partially inserted into the annular groove 1111, that is, the cover 112 can cover a top opening of the isolation chamber 113. In an implementation mode, a gap between the annular groove 1111 and the annular wall 1121 can be filled and sealed by injecting a waterproof adhesive. In an implementation mode, the gap between the annular groove 1111 and the annular wall 1121 can be sealed with a sealing ring.

In an implementation mode, a sealing groove 1122 is provided on one side of the cover 112 facing the base 111. The sealing groove 1122 has a shape matches with a contour of a top of the isolation chamber 113, and the top of the isolation chamber 113 is inserted and matched with the sealing groove 1122. In an implementation mode, a gap between the sealing groove 1122 and the top of the isolation chamber 113 is sealed by injecting a waterproof adhesive. In an implementation mode, the gap between the sealing groove 1122 and the top of the isolation chamber 113 can be sealed with a sealing ring.

In an implementation mode, a step groove 1104 is provided at the top of the isolation chamber 113, which can be used to provide with a waterproof ring or inject with the waterproof adhesive. Where, a top ring 1106 can be provided at the top of the isolation chamber 113, and the step groove 1104 can be provided on the top ring 1106.

Please further refer to FIGS. 1 and 2.

In this embodiment, the waterproof socket 10 further includes a waterproof joint 150 and the switch component 160; the waterproof joint 150 is provided at one end of the housing 110, and the switch component 160 is configured to control the waterproof joint 150 to conduct or disconnect electricity with the socket circuit 120.

Where the waterproof joint 150 can be an aviation joint. The waterproof joint 150 includes a joint part 151, a waterproof ring 152, and a shell 153. The waterproof joint 150 is fixedly connected to one end of the housing 110; the shell 153 is sleeved on the joint part 151 and screwed with the joint part 151; where, the waterproof ring 152 is sleeved on the joint part 151 to fill a gap between the shell 153 and the joint part 151, thereby achieving sealing filling.

Where the switch component 160 includes an installation base 161, a switch button 162, and an external button 163. The installation base 161 is provided in the housing 110, and the switch button 162 can be movably installed on the installation base 161. Where, the external button 163 is sleeved on the switch button 162 and is configured to be exposed to the housing 110. A waterproof skirt 1631 is provided at a bottom of the external button 163, which can fill a gap between the installation base 161 and the cover 112, thereby achieving waterproof sealing of a position of the switch button 162.

Where, a clamp slot 1124 is provided on the cover 112, and the external button 163 is embedded in the clamp slot 1124.

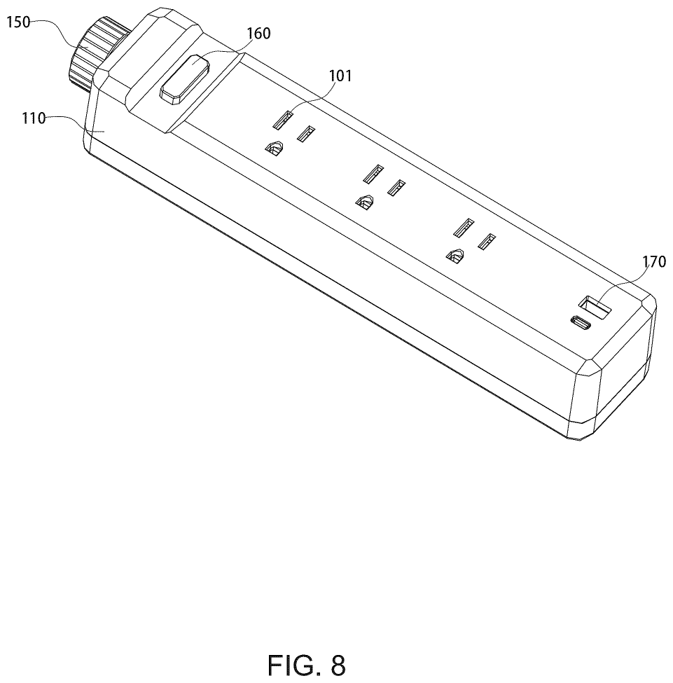

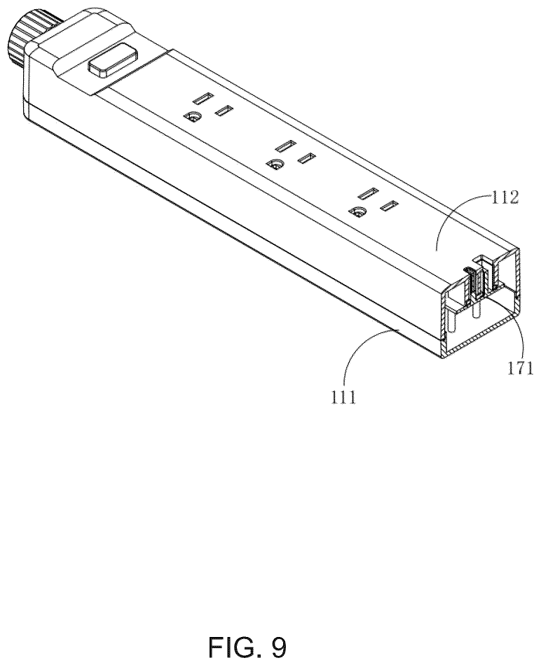

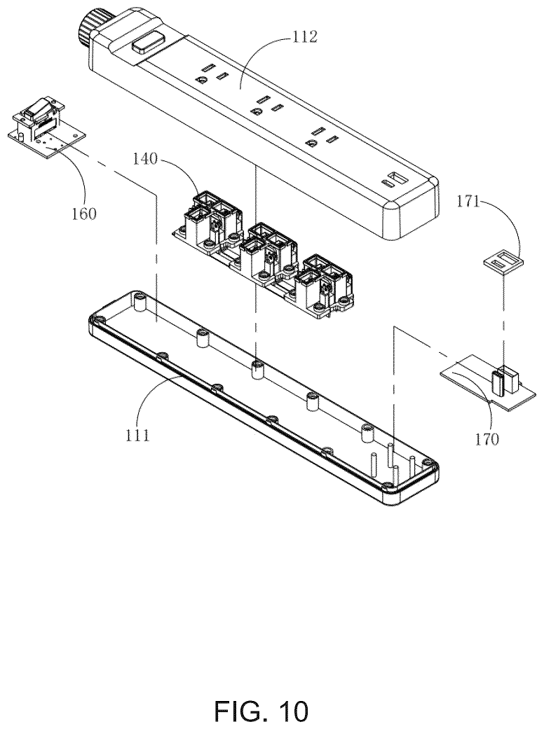

Please further refer to FIGS. 8-10. FIG. 8 is a schematic structural diagram of the waterproof socket provided in another embodiment of the present application; FIG. 9 is a schematic sectional view of the waterproof socket provided in another embodiment the present application; FIG. 10 is an exploded schematic diagram of the waterproof socket provided in another embodiment of the present application.

Where, different functional interfaces 170 such as USB interface and Type-C connector are further provided on the waterproof socket 10. A waterproof component 171 is further provided on the functional interface 170, which is located below the functional interface 170 and is used to seal a gap of the functional interface 170, thus having a waterproof effect. The functional interface 170 can further provided with the isolation chamber 113, the adapter 130, and the triggering component 140 to achieve its waterproof function.

In summary, the present application provides a waterproof socket, which seals the socket circuit in the first installation space and allows the plug and the adapter to be provided in the second installation space. By providing with the triggering component, the movable part of the plug can be located at the second end of the second installation space, thereby causing the movable part to move at the first end of the first installation space. This enables the electrical connection of the socket circuit, the movable part, the adapter, and the plug in sequence. The first and the second installation spaces are filled with a sealing element and are not communicated, thus avoiding water from entering the first installation space and improving the safety of the socket circuit, thereby improving the overall waterproof performance of the waterproof socket and enhancing the safety of the waterproof socket.

The above are only embodiments of the present application and do not limit the scope of the present application. Any equivalent structure or equivalent process transformation made using the content of this specification and drawings, or directly or indirectly applied in other related technical fields, are also included in the protection scope of the present application.

What is claimed is:

1. A waterproof socket, comprising:
a housing, which comprises a base and a cover that are matched with each other, the base and the cover are connected to form an installation cavity; the base is provided with an isolation chamber, which divides the installation cavity into a first installation space and a second installation space that are not communicated with each other;
a socket circuit provided in the first installation space;
an adapter provided in the second installation space, the cover is provided with a jack socket at a position corresponding to the second installation space, the jack socket is configured to be matched with a plug; the plug is electrically connected to the adapter when the plug is inserted into the jack socket;
a triggering component, which comprises a movable part that penetrates the isolation chamber, a first end of the movable part is facing towards the socket circuit, a second end of the movable part forms an electrical connection with the adapter;
wherein the waterproof socket is configured to directly or indirectly trigger the first end of the movable part to be electrically connected to the socket circuit when the plug is inserted into the jack socket.

2. The waterproof socket according to claim 1, wherein the adapter comprises a bottom wall and two elastic walls connected to two opposite ends of the bottom wall;
one ends of the two elastic walls away from the bottom wall are capable of being abutting against each other;
wherein the plug comprises a plug-in part, one plug-in part of the plug is inserted between the two elastic walls so as to achieve an electrical connection between the adapter and the plug-in part.

3. The waterproof socket according to claim 2, wherein the triggering component further comprises a triggering spring, which is connected to the adapter and located on one side of one of the two elastic walls;
the triggering spring is configured to abut against the movable part with direct or indirect contact of the plug when the plug is inserted into the jack socket, thereby driving the movable part to move and abut against a contact part in the socket circuit;
the contact part is electrically connected with the adapter by the movable part.

4. The waterproof socket according to claim 3, wherein the triggering spring comprises a bottom piece and two side pieces connected to the bottom piece, one ends of the two side pieces are connected to two opposite ends of the bottom piece; the other ends of the two side pieces abut against two opposite sides of one of the two elastic walls;
the bottom piece and the bottom wall are fixedly connected by a fastener.

5. The waterproof socket according to claim 2, wherein the isolation chamber forms at least two second installation spaces, each of the at least two second installation spaces is provided corresponding to one plug-in part of the plug.

6. The waterproof socket according to claim 1, wherein the isolation chamber is capable of being disassembled and installed on the base;
the cover is covered on the base, an edge area of the base is provided with an annular groove; an edge of the cover has an annular wall that matches with the annular groove, and at least a part of the annular wall is capable of being inserted into the annular groove.

7. The waterproof socket according to claim 6, wherein a gap between the annular groove and the annular wall is filled and sealed by injecting a waterproof adhesive.

8. The waterproof socket according to claim 7, wherein the gap between the annular groove and the annular wall is filled and sealed with a sealing ring.

9. The waterproof socket according to claim 6, wherein the cover is provided with a sealing groove on one side of the cover facing the base, the sealing groove has a shape that matches with a contour of a top of the isolation chamber;
the top of the isolation chamber is inserted and matched with the sealing groove;
a gap between the sealing groove and the top of the isolation chamber is sealed by injecting a waterproof adhesive.

10. The waterproof socket according to claim 9, wherein the gap between the sealing groove and the top of the isolation chamber is sealed with a sealing ring.

11. The waterproof socket according to claim 1, wherein the waterproof socket further comprises a waterproof joint and a switch component;
the waterproof joint is provided at one end of the housing, and the switch component is configured to control a connection or a disconnection of the waterproof joint with the socket circuit.

12. The waterproof socket according to claim 11, wherein the waterproof socket is further provided with a functional interface.
